(19) United States
(12) Patent Application Publication
(10) Pub. No.: US 2004/0080288 A1
(43) Pub. Date: Apr. 29, 2004

(54) Fan motor control for a ventilation system

(76) Inventor: Kiyoshi Ina, Commerce Township, MI (US)

Correspondence Address: Jordan M. Meschkow, Meschkow & Gresham, P.L.C., Suite 409, 5727 North Seventh Street, Phoenix, AZ, 85014, US

(21) Appl. No.: 10/283,680

(22) Filed: Oct. 29, 2002

(51) Int. Cl. H02P 7/38

(52) U.S. Cl. 318/163

(57) ABSTRACT

A ventilation system (20) made up of a wiring harness (22), a power source (21), a fan motor (23), a resistance circuit (70), and a selector switch (30-or 40) is taught. The selector switch (30 or 40) has five or six positions, and determines a different current through the fan motor (23) for each position. The resistance circuit (70) limits the current in three or four of the positions. A control apparatus (25) is mechanically coupled to the selector switch (23) and configured to allow a user to select one of the positions. One of the positions is an “off” position passing zero current through the fan motor (23), and one of the positions is a “maximum” position passing a maximum current through the fan motor (23). Each of the other positions is intermediate and passes a current through the fan motor (23) and a resistance in the resistance circuit (70) to limit the current.

### TECHNICAL FIELD OF THE INVENTION

The present invention relates to the field of ventilation systems. More specifically, the present invention relates to the field of fan motor control in automotive ventilation systems.

### BACKGROUND OF THE INVENTION

In the manufacture of automobiles and other vehicles, otherwise-identical vehicles are often-differentiated solely by peripheral or “luxury” items. For example, the “standard” and “luxury” models of a given car may be identical except for an option package, wherein the “standard” package contains a given engine, manual windows, manual door locks, and a four-speed air-conditioner/ventilation fan, while the “luxury” package contains a larger engine, electric windows, electric door locks, and a five-speed air-conditioner/ventilation fan.

It is desirous that the basic vehicle contains as few model-differentiated components as possible. For example, if the vehicle were to be designed so that all model-differentiated components may be installed during the final stages of assembly, then the “raw” vehicles may be held at the non-model-specific stage until a given model is called for. This results in finer control over production, leading to improvements in distribution and inventory control, and ultimately may result in significant cost benefits.

In the area of heating, ventilation, and air-conditioning (HVAC), different models often have different controls. These differences may be exemplified by the number of speeds in a ventilation fan, with more luxurious models having finer fan control, i.e., more fan speeds. Unfortunately, this typically required the use of a differentiated wiring harness for the variant fan-control connections.

Since wiring harnesses are typically installed early in vehicle production, the use of different wiring harnesses for different models requires model-level commitment at an early production stage. This is both costly and inefficient.

Alternatively, wiring harnesses may be used that have multiple-model wiring, i.e., extra wires in the harness to allow for the more luxurious models. This, too, poses problems. Not only is the inclusion of the extra wires an unnecessary expense for the less luxurious models, but the possibility exist of confusion between and/or misapplication of connectors during manufacturing quality control, and during downstream repairs and maintenance.

### SUMMARY OF THE INVENTION

Accordingly, it is an advantage of the present invention that a fan motor control for a ventilation system is provided.

It is another advantage of the present invention that a single wiring harness is used with either a four-speed or five-speed fan motor control.

It is another advantage of the present invention that a single resistor network is used with either a four-speed or five-speed fan motor control.

The above and other advantages of the present invention are carried out in one form by a control assembly for a fan motor in a ventilation system. The control assembly incorporates a resistor network comprising a plurality of resistors, and a selector switch electrically coupled to the fan motor and the resistor network, where the switch has 5 or 6 positions, determines a different current through the fan motor for each of the 5 or 6 positions, and the resistor network limits the current in 3 or 4 of the 5 or 6 positions, respectively.

The above and other advantages of the present invention are carried out in another form by a method of controlling a fan motor in an automotive ventilation system. The method includes setting a selector switch to one of 5 or 6 positions, establishing a current through the fan motor in response to the setting of the selector switch, and operating the fan motor as a function of the established current.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a schematic view of an automotive ventilation system having a six-position selector switch in a first “off” position in accordance with a preferred embodiment of the present invention;

FIG. 2 shows a schematic view of the automotive ventilation system of FIG. 1 demonstrating current flow when the selector switch is in a second “low” position in accordance with a preferred embodiment of the present invention;

FIG. 3 shows a schematic view of the automotive ventilation system of FIG. 1 demonstrating current flow when the selector switch is in a third “medium-low” position in accordance with a preferred embodiment of the present invention;

FIG. 4 shows a schematic view of the automotive ventilation system of FIG. 1 demonstrating current flow when the selector switch is in a fourth “medium” position in accordance with a preferred embodiment of the present invention;

FIG. 5 shows a schematic view of the automotive ventilation system of FIG. 1 demonstrating current flow when the selector switch is in a fifth “medium-high” position in accordance with a preferred embodiment of the present invention;

FIG. 6 shows a schematic view of the automotive ventilation system of FIG. 1 demonstrating current flow when the selector switch is in a fifth “high” position in accordance with a preferred embodiment of the present invention;

FIG. 7 shows a schematic view of an automotive ventilation system having a five-position selector switch in a first “off” position in accordance with an alternative preferred embodiment of the present invention;

FIG. 8 shows a schematic view of the automotive ventilation system of FIG. 7 demonstrating current flow when the selector switch is in a second “low” position in accordance with an alternative preferred embodiment of the present invention;

FIG. 9 shows a schematic view of the automotive ventilation system of FIG. 7 demonstrating current flow when the selector switch is in a third “medium-low” position in accordance with an alternative preferred embodiment of the present invention;

FIG. 10 shows a schematic view of the automotive ventilation system of FIG. 7 demonstrating current flow when the selector switch is in a fourth “medium-high” position in accordance with an alternative preferred embodiment of the present invention; and

FIG. 11 shows a schematic view of the automotive ventilation system of FIG. 7 demonstrating current flow when the selector switch is in a fifth “high” position in accordance with an alternative preferred embodiment of the present invention.

### DETAILED DESCRIPTION OF THE PREFERRED EMBODIMENTS

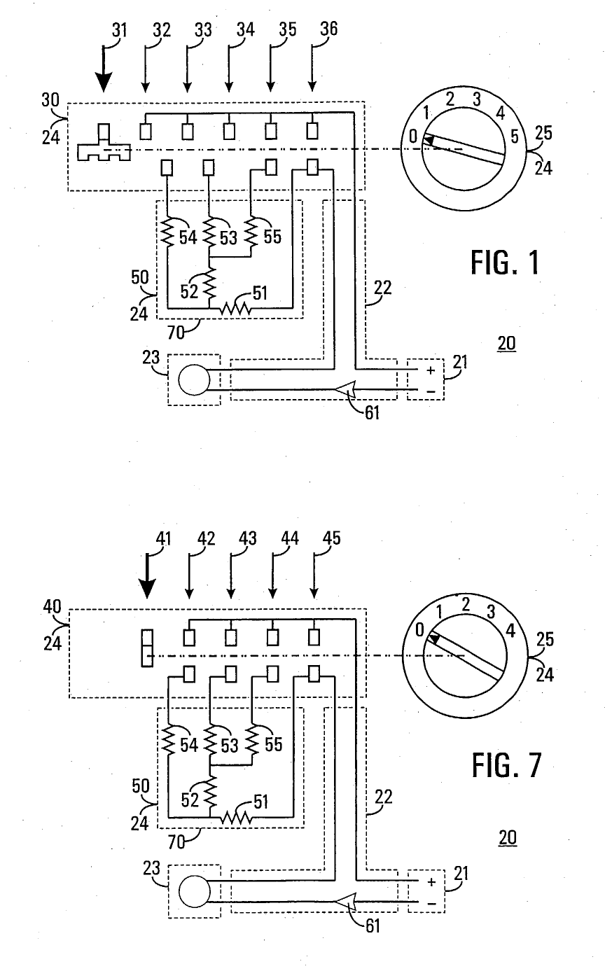

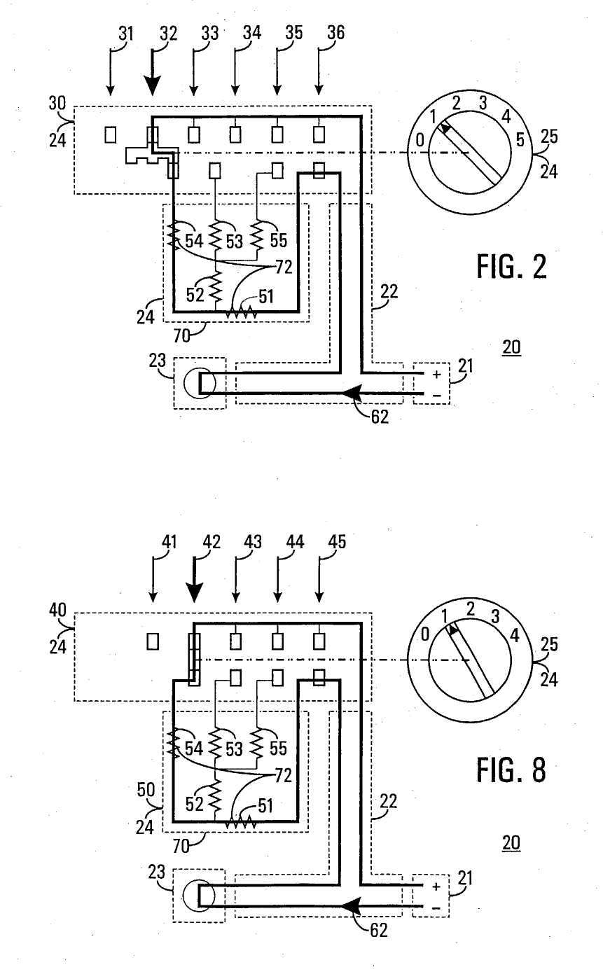

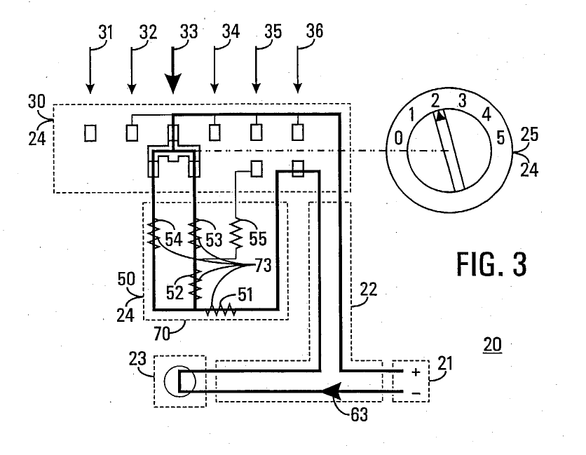

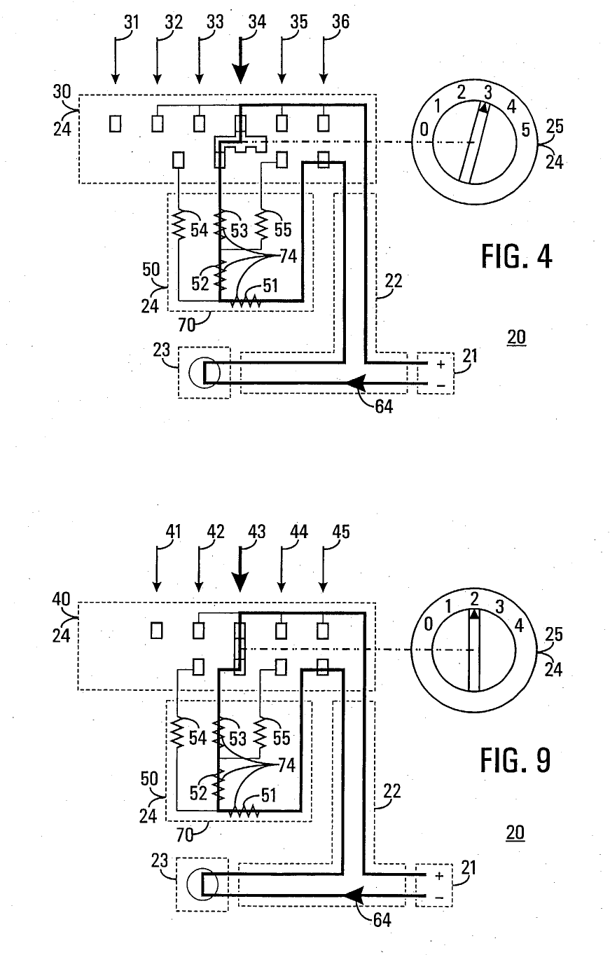

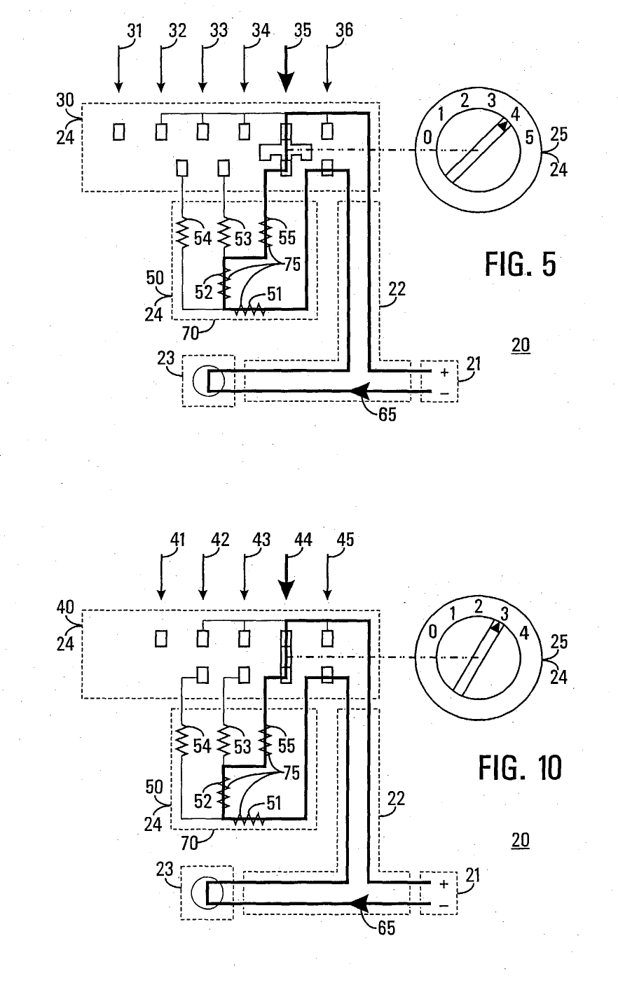

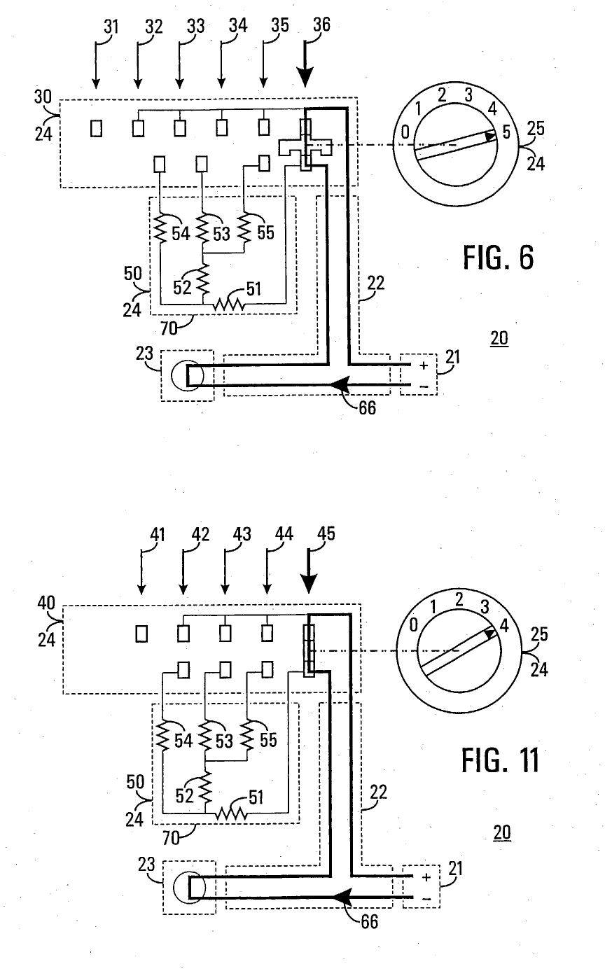

FIGS. 1 through 6 show schematic views of an automotive ventilation system 20 having a six-position selector switch 30 in a first “off” position 31 (FIG. 1), and demonstrating current flow when selector switch 30 is in a second “low” position 32 (FIG. 2), a third “medium-low” position 33 (FIG. 3), a fourth “medium” position 34 (FIG. 4), a fifth “medium-high” position 35 (FIG. 5), and a sixth “high” position 36 (FIG. 6) in accordance with a preferred embodiment of the present invention. Similarly, FIGS. 7 through 11 show schematic views of automotive ventilation system 20 having a five-position selector switch 40 in a first “off” position 41 (FIG. 7), and demonstrating current flow when selector switch 40 is in a second “low” position 42 (FIG. 8), a third “medium-low” position 44 (FIG. 9), a fourth “medium-high” position 45 (FIG. 10), and fifth “high” position 46 (FIG. 11) in accordance with an alternative preferred embodiment of the present invention. The following discussion refers to FIGS. 1 through 11.

Ventilation system 20 may be used as a part of an automotive heating, ventilation, and air-conditioning (HVAC) system as found in cars, truck, boats, aircraft, and other vehicles. Those skilled in the art will appreciate that system 20 is not limited to vehicular use, however, and may be used wherever flexible ventilation control is desired and a resistive fan speed control is appropriate.

Ventilation system 20 consists of a power source 21, a wiring harness 22, a fan motor 23, and a control assembly 24. Control assembly 24 is in turn made up of selector switch 30 or 40, a resistor network 50, and a control apparatus 25. Control apparatus 25 is made up of a selector and linkages necessary to set selector switch 30 or 40 to any desired position.

Selector switches 30 and 40 have N positions, where N=6 for selector switch 30 (FIGS. 1 through 6), and N=5 for selector switch 40 (FIGS. 7 through 11). Since one of these positions is an “off” position, selector switches 30 and 40 are five-speed and four-speed selector switches, respectively.

Control apparatus 25 is depicted in FIGS. 1 through 6 as a knob having N=6 positions, labeled “0”, “1”, “2”, “3”, “4”, and “5”, and coupled to six-position selector switch 30. Through the use of control apparatus 25, selector switch 30 may be positioned to an “off” position P₍₁₎ 31 (FIG. 1), a “low-speed” position P₍₂₎ 32 (FIG. 2), a “medium-low-speed” position P_{(N-3)} (where N−3=6−3=3) 33 (FIG. 3), a “medium-speed” position P_{(N-2)} (where N−2=6−2=4) 34 (FIG. 4), a “medium-high-speed” position P_{(N-1)} (where N−1=6−1=5) 35 (FIG. 5), and a “high-speed” or “maximum” position P_{(N)} where N=6) 36 (FIG. 6).

Similarly, control apparatus 25 is depicted in FIGS. 7 through 11 as a knob having N=5 positions, labeled “0”, “1”, “2”, “3”, and “4”, and coupled to five-position selector switch 40. Through the use of control apparatus 25, selector switch 40 may be positioned to an “off” position P₍₁₎ 41 (FIG. 7), a “low-speed” position P₍₂₎ 42 (FIG. 8), a “medium-low-speed” position P_{(N-2)} (where N−2=5−2=3) 44 (FIG. 9), a “medium-high-speed” position P_{(N-1)} (where N−1=5−1=4) 45 (FIG. 10), and a “high-speed” or “maximum” position P_{(N)} where N=5) 46 (FIG. 11).

Those skilled in the art will appreciate that the speed labels discussed hereinbefore are relative only to the speed of fan motor 23 when used in conjunction with that particular selector switch 30 or 40. That is, the labels “low-speed,” “medium-low-speed,” “medium-speed,” “medium-high-speed,” and “high-speed” used in conjunction with six-position selector switch 30 are germane only in relation to each other when fan motor 23 is used with six-position selector switch 30, and the labels “low-speed,” “medium-low-speed,” “medium-high-speed,” and “high-speed” used in conjunction with five-position selector switch 40 are germane only in relation to each other when fan motor 23 is used with five-position selector switch 40.

On the other hand, the labels “off” and “maximum” represent absolute speed terms of zero and maximum speed of fan motor 23 regardless of whether selector switch 30 or 40 is used.

Referring to FIGS. 1 and 7, setting selector switch 30 or 40 to position P₍₁₎ 31 or 41, respectively, an “off” setting, interrupts the circuit to fan motor 23 from power source 21. This establishes a current I₍₁₎ 61 through fan motor 23 to be zero, and fan motor 23 operates as off (i.e., attain a speed of zero).

Referring to FIGS. 6 and 11, setting selector switch 30 or 40 to position P_{(N)} 36 or 46, respectively, a “maximum” setting, places fan motor 23 directly across power source 21. This establishes a current I_{(N)} 66 through fan motor 23 to be a maximum current, and fan motor 23 operates at a maximum speed.

Referring to FIGS. 1 through 11, resistor network 50 is made up of resistors R₁ 51, R₂ 52, R₃ 53, R₄ 54, and R₅ 55. Together, resistors R₁ 51, R₂ 52, R₃ 53, R₄ 54, and R₅ 55 form a resistance circuit 70. Resistor network 50 and resistance circuit 70 are the same regardless of whether six-position selector switch 30 (FIGS. 1 through 6) or five-position selector switch 40 (FIGS. 7 through 11) is used. Each current path through resistance circuit 70 encounters a different resistance.

Referring to FIGS. 2 and 8, setting selector switch 30 or 40 to position P₍₂₎ 32 or 42, respectively, establishes a current I₍₂₎ 62 through fan motor 23 and a resistance R₍₂₎ 72 of resistance circuit 70. Resistance R₍₂₎ 72 is made up of resistors R₁ 51 and R₄ 54 in series. That is:

R₍₂₎=R₁+R₄ (1)

Since current I₍₁₎ 61 (FIGS. 1 and 7) is zero, current I₍₂₎ 62 is greater than current I₍₁₎ 61 (FIGS. 1 and 7).

Referring to FIG. 3, setting selector switch 30 to position P_{(N-3)} 33 establishes a current I_{(N-3)} 63 through fan motor 23 and a resistance R_{(N-3)} 73 of resistance circuit 70. Resistance R_{(N-3)}73 is made up of resistor R₁ 51 in series with a combination of resistor R₄ 54 in parallel with a combination of resistors R₂ 52 and R₃ 53 in series. That is:

R_{(N-3)}=R₁+[(R₄)⁻¹+(R₂+R₃)⁻¹]¹ (2)

Resistance R_{(N-3)} 73 is less than resistance R₍₂₎ 72 (FIG. 2), therefore current I_{(N-3)} 63 is greater than current I₍₂₎ 62 (FIG. 2).

It will be noted that there is no current I_{(N-3)} 63 for five-position selector switch 40, i.e., there is no five-position Figure corresponding to six-position FIG. 3. In the preferred embodiments, it is current I_{(N-3)} 63, and its corresponding fan-motor speed, that has been removed to accommodate five-position selector switch 40.

Those skilled in the art will appreciate that, while any current and corresponding speed may be removed without affecting the spirit of the present invention, it is desirable that a current representing a “medium” fan speed be removed, i.e., one of currents I_{(N-3)} 63, I_{(N-2)} 64, or I_{(N-1)} 65 (currents I_{(N-2)} 64 and I_{(N-1)} 65 discussed hereinafter). It will readily be appreciated that several functions in an HVAC system require some air movement, but a minimal air movement is advantageous. For this reason, it is desirable that the lowest fan speed be retained, i.e., current I₍₂₎ 62. It will also be appreciated there will often be conditions under which a maximum movement of air is advantageous. Therefore, it is desirable that the highest fan speed be retained, i.e., current I_{(N)} 66. In the preferred embodiment depicted in FIGS. 7 through 11, current I_{(N-3)} 63 has been eliminated, but either of currents I_{(N-2)} 64 or I_{(N-1)} 65 may be eliminated instead without departing from the spirit of the present invention.

Referring to FIGS. 4 and 9, setting selector switch 30 or 40 to position P_{(N-2)} 34 or 44, respectively, establishes current I_{(N-2)} 64 through fan motor 23 and a resistance R_{(N-2)} 74 of resistance circuit 70. Resistance R_{(N-2)} 74 is made up of resistors R₁ 51, R₂ 52, and R₃ 53 in series. That is:

R_{(N-2)}=R₁+R₂+R₃ (3)

Resistance R_{(N-2)} 74 is less than resistance R_{(N-3)} 73 (FIG. 3) or resistance R₍₂₎ 72 (FIG. 8), therefore current I_{(N-2)} 64 is greater than current I_{(N-3)} 63 (FIG. 3) or current I₍₂₎ 62 (FIG. 8).

Referring to FIGS. 5 and 10, setting selector switch 30 or 40 to position P_{(N-1)} 35 or 45, respectively, establishes current I_{(N-1)} 65 through fan motor 23 and a resistance R_{(N-1)} 75 of resistance circuit 70. Resistance R_{(N-1)} 75 is made up of resistors R₁ 51, R₂ 52, and R₅ 55 in series. That is:

R_{(N-1)}=R₁+R₂+R₅ (4)

Resistance R_{(N-1)} 75 is less than resistance R_{(N-2)} (FIGS. 4 and 9), therefore current I_{(N-1)} 65 is greater than current I_{(N-2)} 64 (FIGS. 4 and 9).

In summary, the present invention teaches a speed control assembly 24 for a ventilation system 20. A single wiring harness 22 and a single resistor network 50 is used with either a five-position (four-speed) selector switch 40 or a six-position (five-speed) selector switch 30.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A control assembly for a fan motor in a ventilation system, said assembly comprising:
a resistor network comprising a plurality of resistors; and
a selector switch electrically coupled to said fan motor and said resistor network, wherein:
said selector switch has N positions, where N=5 or N=6;
said selector switch determines a current through said fan motor;
said current is different for each of said N positions; and
said resistor network limits said current in N−2 of said N positions.

2. A control assembly as claimed in claim 1 additionally comprising a control apparatus mechanically coupled to said selector switch and configured to allow a user to select one of said N positions of said selector switch.

3. A control assembly as claimed in claim 1 wherein:
said plurality of resistors in said resistor network comprise a first resistance circuit when N=5;
said plurality of resistors in said resistor network comprise a second resistance circuit when N=6; and
said second resistance circuit is substantially identical to said first resistance circuit.

4. A control assembly as claimed in claim 1 wherein:
said resistor network comprises a resistance circuit;
when said selector switch is in a position P_{(N)}:
said fan motor is electrically coupled directly to a power source of said ventilation system; and
said current through said fan motor is a current I_{(N)}, where said current I_{(N)} is a maximum current;
when said selector switch is in a position P_{(N-1)}:
said fan motor is electrically connected to said power source in series with a resistance R_{(N-1)} of said resistance circuit; and
said current through said fan motor is a current I_{(N-1)}, where said current I_{(N-1)} is less than said current I_{(N)};
when said selector switch is in a position P_{(N-2)}:
said fan motor is electrically connected to said power source in series with a resistance R_{(N-2)} of said resistance circuit; and
said current through said fan motor is a current I_{(N-2)}, wherein said current I_{(N-2)} is less than said current I_{(N-1)};
when said selector switch is in a position P₍₂₎:
said fan motor is electrically connected to said power source in series with a resistance R₍₂₎ of said resistance circuit; and
said current through said fan motor is a current I₍₂₎, wherein said current I₍₂₎ is less than said current I_{(N-2)}; and
when said selector switch is in a position P₍₁₎:
said fan motor is electrically disconnected from said power source; and
said current through said fan motor is a current I₍₁₎, wherein said current I₍₁₎ is zero.

5. A control assembly as claimed in claim 4 wherein, when N=6 and said selector switch is in a position P_{(N-3)}:
said fan motor is electrically connected to said power source in series with a resistance R_{(N-3)} of said resistance circuit; and
said current through said fan motor is a current I_{(N-3)}, wherein said current I_{(N-3)} is less than said current I_{(N-2)} and greater than said current I₍₂₎.

6. A control assembly as claimed in claim 1 wherein:
said resistor network comprises:
a resistor R₁;
a resistor R₂ in series with said resistor R₁;
a resistor R₃ in series with said resistors R₁ and R₂;
a resistor R₄ in series with said resistor R₁ and in parallel with said resistors R₂ and R₃ in series;
a resistor R₅ in series with said resistors R₁ and R₂; and
a resistance circuit formed of said resistors R₁, R₂, R₃, R₄, and R₅;
said resistance circuit comprises:
a resistance R_{(N-1)} configured for use when said selector switch is in a position P_{(N-1)} and comprising said resistors R₁, R₂, and R₅;
a resistance R_{(N-2)} configured for use when said selector switch is in a position P_{(N-2)} and comprising said resistors R₁, R₂, and R₃;
a resistance R_{(N-3)} configured for use when N=6 and said selector switch is in a position P_{(N-3)} and comprising said resistors R₁, R₂, R₃, R₄; and
a resistance R₍₂₎ configured for use when said selector switch is in a position P₍₂₎ and comprising said resistors R₁ and R₄.

7. A control assembly as claimed in claim 1 wherein:
said selector switch has 6 positions; and
said current through said fan motor is one of:
a first current when said selector switch is in a first one of said 6 positions, wherein said first current is a current I₍₁₎, and I₍₀₎=0;
a second current when said selector switch is in a second one of said 6 positions, wherein said second current is a current I₍₂₎, and I₍₂₎>I₍₁₎;
a third current when said selector switch is in a third one of said 6 positions, wherein said third current is a current I_{(N-3)}, and I_{(N-3)}>I₍₂₎;
a fourth current when said selector switch is in a fourth one of said 6 positions, wherein said fourth current is a current I_{(N-2)}, and I_{(N-2)}>I_{(N-3)};
a fifth current when said selector switch is in a fifth one of said 6 positions, wherein said fifth current is a current I_{(N-1)}, and I_{(N-1)}>I_{(N-2)}; and
a sixth current when said selector switch is in a sixth one of said 6 positions wherein said sixth current is a current I_{(N)}, and I_{(N)}>I_{(N-1)}.

8. A control assembly as claimed in claim 1 wherein:
said selector switch has 5 positions; and
said current through said fan motor is one of:
a first current when said selector switch is in a first one of said 5 positions, wherein said first current is a current I₍₁₎, and I₍₁₎=0;
a second current when said selector switch is in a second one of said 5 positions, wherein said second current is a current I₍₂₎, and I₍₂₎>I₍₁₎;
a third current when said selector switch is in a third one of said 5 positions, wherein said third current is one of a current I_{(N-3)} and a current I_{(N-2)}, and I_{(N-2)}>I_{(N-3)}>I₍₂₎;
a fourth current when said selector switch is in a fourth one of said 5 positions, wherein said fourth current is one of a current I_{(N-2)} and a current I_{(N-1)}, and I_{(N-1)}>I_{(N-2)}>I_{(N-3)}; and
a fifth current when said selector switch is in a fifth one of said 5 positions, wherein said fifth current is a current I_{(N)}, and I_{(N)}>I_{(N-1)}.

9. A control assembly as claimed in claim 8 wherein:
said third current is said current I_{(N-2)}; and
said fourth current is said current I_{(N-1)}.

10. A method of controlling a fan motor in an automotive ventilation system, said method comprising:
setting a selector switch to one of N positions, where N is 5 or 6;
establishing a current through said fan motor in response to said setting activity; and
operating said fan motor as a function of said current established in said establishing activity.

11. A method as claimed in claim 10 wherein:
said establishing activity establishes said current as a current I₍₁₎ substantially equal to zero when said setting activity sets said selector switch to a position P₍₁₎;
said establishing activity establishes said current as a current I₍₂₎ greater than said current I₍₁₎ when said setting activity sets said selector switch to a position P₍₂₎;
said establishing activity establishes said current as a current I_{(N-3)} greater than said current I₍₂₎ when N=6 and said setting activity sets said selector switch to a position P_{(N-3)};
said establishing activity establishes said current as a current I_{(N-2)} greater than said current I_{(N-3)} when said setting activity sets said selector switch to a position P_{(N-2)};
said establishing activity establishes said current as a current I_{(N-1)} greater than said current I_{(N-2)} when said setting activity sets said selector switch to a position P_{(N-1)}; and
said establishing activity establishes said current as a current I_{(N)} greater than said current I_{(N-1)} when said setting activity sets said selector switch to a position P_{(N)}.

12. An automotive ventilation system comprising:
a wiring harness;
a power source electrically coupled to said wiring harness;
a fan motor electrically coupled to said wiring harness;
a resistance circuit; and
a selector switch electrically coupled to said wiring harness and said resistance circuit, wherein:
said selector switch has N positions, where N is 5 or 6;
said selector switch determines a current through said fan motor;
said current is different for each of said N positions; and
said resistance circuit limits said current in N−2 of said N positions.

13. An automotive ventilation system as claimed in claim 12 additionally comprising a control apparatus mechanically coupled to said selector switch and configured to allow a user to select one of said N positions of said selector switch.

14. An automotive ventilation system as claimed in claim 12 wherein:
one of said N positions of said selector switch is an “off” position; and
said current through said fan motor is zero when said selector switch is in said “off” position.

15. An automotive ventilation system as claimed in claim 12 wherein:
one of said N positions of said selector switch is a “maximum” position; and
said resistance circuit has no effect upon said current through said fan motor when said selector switch is in said “maximum” position.

16. An automotive ventilation system as claimed in claim 12 wherein N=5, and wherein each of said positions of said selector switch is one of:
a position P_{(N)} wherein:
said fan motor is electrically coupled directly to said power source;
said current through said fan motor is a current I_{(N)}; and
said current I_{(N)} is a maximum current;
a position P_{(N-1)} wherein:
said fan motor is electrically connected to said power source through a resistance R_{(N-1)} of said resistance circuit;
said current through said fan motor is a current I_{(N-1)}; and
said current I_{(N-1)} is less than said current I_{(N)};
a position P_{(N-2)} wherein:
said fan motor is electrically connected to said power source through a resistance R_{(N-2)} of said resistance circuit;
said resistance R_{(N-2)} is greater than said resistance R_{(N-1)};
said current through said fan motor is a current I_{(N-2)}; and
said current I_{(N-2)} is less than said current I_{(N-1)};
a position P₍₂₎ wherein:
said fan motor is electrically connected to said power source through a resistance R₍₂₎ of said resistance circuit;
said resistance R₍₂₎ is greater than said resistance R_{(N-2)};
said current through said fan motor is a current I₍₂₎; and
said current I₍₂₎ is less than said current I_{(N-2)}; and
a position P₍₁₎ wherein:
said fan motor is electrically disconnected from said power source;
said current through said fan motor is a current I₍₁₎; and
said current I₍₁₎ is zero.

17. An automotive ventilation system as claimed in claim 12 wherein N=6, and wherein each of said positions of said selector switch is one of:
a position P_{(N)} wherein:
said fan motor is electrically coupled directly to said power source;
said current through said fan motor is a current I_{(N)}; and
said current I_{(N)} is a maximum current;
a position P_{(N-1)} wherein:
said fan motor is electrically connected to said power source through a resistance R_{(N-1)} of said resistance circuit;
said current through said fan motor is a current I_{(N-1)}; and
said current I_{(N-1)} is less than said current I_{(N)};
a position P_{(N-2)} wherein:
said fan motor is electrically connected to said power source through a resistance R_{(N-2)} of said resistance circuit;
said resistance R_{(N-2)} is greater than said resistance R_{(N-1)};
said current through said fan motor is a current I_{(N-2)}; and
said current I_{(N-2)} is less than said current I_{(N-1)};
a position P_{(N-3)} wherein:
said fan motor is electrically connected to said power source through a resistance R_{(N-3)} of said resistance circuit;
said resistance R_{(N-3)} is greater than said resistance R_{(N-2)};
said current through said fan motor is a current I_{(N-3)}; and
said current I_{(N-3)} is less than said current I_{(N-2)}; and
a position P₍₂₎ wherein:
said fan motor is electrically connected to said power source through a resistance R₍₂₎ of said resistance circuit;
said resistance R₍₂₎ is greater than said resistance R_{(N-3)};
said current through said fan motor is a current I₍₂₎; and
said current I₍₂₎ is less than said current I_{(N-3)}; and
a position P₍₁₎ wherein:
said fan motor is electrically disconnected from said power source;
said current through said fan motor is a current I₍₁₎; and
said current I₍₁₎ is zero.
